(19) United States
(12) Patent Application Publication
(10) Pub. No.: US 2007/0004811 A1
(43) Pub. Date: Jan. 4, 2007

(54) Polymerized oil for use as a dust control agent

(75) Inventors: Michael C. Bruner, Naperville, IL (US); Selim M. Erhan, Riverside, IL (US); Brian M. Lenz, Des Plaines, IL (US); Roger Scott Johnson, Snellville, GA (US)

Correspondence Address: BANNER & WITCOFF, 1001 G STREET N W, SUITE 1100, WASHINGTON, DC, 20001, US

(73) Assignee: Georgia-Pacific Resins, Inc., Atlanta, GA (US)

(21) Appl. No.: 11/168,468

(22) Filed: Jun. 29, 2005

(51) Int. Cl. C08J 5/20; C09K 3/22

(52) U.S. Cl. 521/27; 252/88.1

(57) ABSTRACT

An aqueous dispersion of a polymerized (e.g., oxidized) oil, preferably an oxidized vegetable oil, suitable for reducing dusting in industrial processes, prepared by using, as the primary dispersing (emulsification) agent, a sulfated or sulfonated oil (also preferably a sulfated or sulfonated vegetable oil) to disperse the polymerized oil.

### FIELD OF THE INVENTION

The present invention relates to the use of an aqueous dispersion of a polymerized (e.g., oxidized) oil, preferably an oxidized vegetable oil, to reduce dusting in industrial processes, such as in coal handling, grain handling and especially in fiberglass production and handling. The aqueous dispersion is prepared by using, as the primary dispersing (emulsification) agent, a sulfated or sulfonated oil (also preferably a sulfated or sulfonated vegetable oil) to disperse the polymerized oil.

The dispersion can be made as a concentrate in a small amount of water. This concentrated dispersion is easily dispersed in a larger amount of water to form the de-dusting composition.

### BACKGROUND OF THE INVENTION

A low-cost and effective way of controlling fugitive dust has been a longstanding objective for industrial processes.

Fugitive dust is confronted in a wide variety of circumstances where granular particulates are manufactured, handled or generally encountered. Surfaces such as dirt roads and dirt parking lots generate substantial dust when driven over by vehicles and can generate dust in windy weather conditions. Substantial amounts of dust also are encountered in connection with coal mines and other types of mines and in various other areas where coal particles, rock dust (limestone), clay, slate, fertilizers and other finely divided particles are generated or present on various types of surfaces. Fugitive dust is also a problem when handling, transporting and storing pulverized and powdery (particulate) materials such as when transporting grains, minerals and fertilizers, including the transport, for example, of coal across the country leading to material losses by wind erosion during transit. Dust formation also can be a problem in the manufacturing and handling of fiberglass insulation and related products. The dust is produced during the manufacture, storage, transportation and/or handling of such products.

Fugitive dust can cause poor visibility and dangerous driving conditions, fugitive dust can contribute to lower productivity at mines and other industrial and farming sites, and fugitive dust can be irritating to the eyes and mucous membrane, especially the nasal passages and ultimately can contribute to respiratory problems for animals and humans.

One common method for reducing the incidence of fugitive dust is to apply a water spray, particularly on mining roads, quarry access roads, and other types of dusty areas supporting traffic. Water spray controls the dust for at most only a short period of time depending on climate conditions, and has to be applied frequently. Petroleum products, such as diesel fuel, and other chemicals such as magnesium chloride, re-claimed asphaltic materials, resins, lignins, lignin sulfonates and the like also have been used to spread on dust roads to reduce dust and erosion. Such products can contribute to contamination of water supplies.

U.S. Pat. No. 4,780,233, U.S. Pat. No. 5,256,419 and U.S. Pat. No. 5,500,220 describe using an aqueous foam carrier of a dust control agent and one of a water insoluble elastomeric polymer, a pesticidal material or a biological control agent, respectively, for dust suppression. An oil (either mineral, vegetable or animal oil) is the main component for dust suppression.

U.S. Pat. No. 6,355,083, U.S. Pat. No. 6,514,331, U.S. Pat. No. 6,514,332 and U.S. Pat. No. 6,776,832 describe compositions suitable for reducing dusting in a variety of contexts and mention the use of an oxidized oil, alone or in combination with non-oxidized oil and wax, as a dust control composition specifically for fertilizers.

U.S. Pat. No. 4,417,992 describes using a liquid dispersion of a water swellable acrylamide polymer to control dust in a variety of applications.

U.S. Pat. No. 6,589,442 describes an aqueous emulsion of a mixture of crude tall oil and vegetable oil as a dust control composition. The oil mixture is preferably emulsified by saponification with a strong base.

U.S. Pat. No. 6,443,661 and U.S. Pat. No. 6,729,805 describe a dust reducing composition based on a fatty acid material, preferably Yellow Grease (a combination of vegetable oil and animal renderings). An emulsifying agent is used to emulsify the fatty acid material in water.

U.S. Pat. No. 6,593,420 describes reducing the generation of dust during the manufacture of fiberglass insulation. An aqueous resin binder composition is prepared from a phenolic thermosetting resin and both a polyhydric alcohol and an acid functional water dispersible oil.

Notwithstanding, these referenced approaches, there remains a need to develop an improved and effective dust control composition that is environmentally friendly as an alternative to prevalent market products and which effectively controls fugitive dust.

### DETAILED DESCRIPTION OF THE INVENTION

The present invention relates to the use of an aqueous dispersion (emulsion) of a polymerized (e.g., oxidized) oil, preferably an oxidized vegetable oil, to reduce dusting in industrial processes, such as in coal production and handling, grain handling, fertilizer production and handling and especially fiberglass production and handling.

The aqueous dispersion of the polymerized oil is prepared by using as the primary dispersing (emulsification) agent a sulfated or sulfonated oil (also preferably a sulfated or sulfonated vegetable oil). The composition is preferably made as a concentrate and possibly a concentrated dispersion in a small amount of water. This concentrate is easily dispersed (self-emulsifying) in a larger amount of water to form a de-dusting composition (dust control agent).

As noted above, the present invention uses as an essential constituent of the dust control agent a polymerized (e.g., an oxidized), non-petroleum oil, preferably an oxidized vegetable oil. Mixtures of such polymerized oils also can be utilized. Polymerized oils are prepared by treating an unsaturated oil (that is an oil having unsaturated fatty acids or fatty acid derivatives), such as a vegetable oil, with a source of oxygen (such as air), generally in the presence of heating. Polymerized oils also can be prepared by heating in the absence of oxygen and such processing is referred to as “heat bodying.” Oxidized oils also are referred to as “blown” oils.

Oils suitable for use in the present invention have double bonds, i.e., sites of unsaturation in their hydrocarbon chains. As a result, such oils often are referred to as unsaturated oils. As well known to those skilled in the art, these oils can be polymerized by heating them, often in the presence of an oxygen source (such as air). This polymerization causes an increase in the viscosity of the oxidized oil. A catalyst is sometimes used to increase the speed of the reaction, reduce the temperature at which the oxidation is conducted, or reduce the time required to attain the desired level of oxidation and associated viscosity increase. The heating and oxidation treatments cause crosslinking of the hydrocarbon chains of the oil via their double bonds (sites of unsaturation). The treatment is continued until a desired viscosity is reached. Those skilled in the art can readily obtain a polymerized oil of a suitable viscosity for specific de-dusting applications, depending for example on the particular particulates to treat, the specific mode of application, the intended formulation, and the like. Polymerized oils, including oxidized oils and particularly the oxidized vegetable oils are commercially available from a number of sources such as: Georgia-Pacific Resins, Inc. (W. 65^{th} Street, Bedford Park, Ill., 60638).

As a representative, though not an exclusive or exhaustive list of vegetable oils that can be used for preparing a polymerized oil and preferably an oxidized oil in connection with the preparation of a dust control agent in accordance with the present invention can be mentioned the following: linseed (flaxseed) oil, castor oil, tung oil, soybean oil, cottonseed oil, olive oil, canola oil, corn oil, sunflower seed oil, coconut oil, safflower oil, tall oil, palm oil and mixtures thereof. It may also be suitable in some cases to use the distillation products of such oils or their distillation residues. In this regard can be mentioned distilled tall oil and tall oil bottoms. Most of these oils contain as one significant constituent linoleic acid, an unsaturated long chain fatty acid as well as other unsaturated fatty acids.

A second, critical component of the composition of the present invention is a sulfated or sulfonated oil. The sulfated or sulfonated oil acts as the dispersing (emulsifying) agent for the polymerized (e.g., oxidized) oil permitting the formation of an oil-in-water dispersion or emulsion. The same oils used to make the principal polymerized oil component of the dust control agent of the present invention can serve as the raw material for making the sulfated and sulfonated oil component. While sulfated and sulfonated vegetable oils are generally preferred for use in preparing the dust control agent, other oils also are contemplated, including sulfonated fish oil, sulfonated lard oil, and bisulfited herring oil. The sulfated or sulfonated oils also can be oxidized, but it is not essential that they are. Such sulfated and sulfonated oils are known water dispersible materials and also are commercially available. Such materials also are available from Georgia-Pacific Resins, Inc. (W. 65^{th} Street, Bedford Park, Ill., 60638).

The polymerized (e.g., oxidized) oil constitutes an essential component of the dust reducing agent of the present invention. The dust reducing agent actually comprises an aqueous dispersion or emulsion of the polymerized (e.g., oxidized oil in water. The dust reducing agent can be prepared by blending a concentrated mixture of the polymerized (e.g., oxidized) oil and the sulfated or sulfonated oil dispersing agent with a large amount of water.

To prepare a dust reducing agent for direct application to particulate solids prone to the generation of fugitive dust, the essential (self-emulsifiable) oil components of a polymerized (e.g., oxidized) oil and a sulfated or sulfonated oil, which are preferably supplied as a concentrate, are mixed with water. The polymerized (e.g., oxidized) oil and the sulfated or sulfonated oil are combined at a weight ratio of polymerized oil to emulsifier oil broadly in the range of 1:99 to 99:1 in the concentrate and ultimately in the dust control agent. In many cases, the polymerized (e.g., oxidized) oil and the sulfated or sulfonated oil are combined at a weight ratio of polymerized oil to emulsifier oil in the range of 2:98 to 98:2. The polymerized (e.g., oxidized) oil and the sulfated or sulfonated oil also can be combined at a weight ratio of polymerized oil to emulsifier oil in the range of 5:95 to 95:5. Finally, the polymerized (e.g., oxidized) oil and the sulfated or sulfonated oil sometimes can be combined at a weight ratio of polymerized oil to emulsifier oil in the range of 10:90 to 95:5.

The concentrate may also contain a small amount of an organic base, such as triethanolamine (up to about 10% of the concentrate and generally no more than about 5%) and a small amount of an inorganic base, such as potassium hydroxide (up to about 5% of the concentrate and generally no more than about 1%). Such inorganic bases are used to adjust pH and control emulsion stability of the ultimate emulsion product. Other alkanolamines, and organic amines can be used provided that they are basic enough to extract acidic protons and produce a water-soluble ammonium salt. Other inorganic bases, such as sodium hydroxide, also can be substituted.

The mixture of polymerized oil and sulfated or sulfonated oil is blended with water broadly at a weight ratio of (emulsified) oil to water of from about 1:99 to about 90:10. In many cases, the mixture of polymerized oil and sulfated or sulfonated oil is blended with water at a weight ratio of (emulsified) oil to water of from about 1:99 to about 80:20. Often, the mixture of polymerized oil and sulfated or sulfonated oil can be blended with water at a weight ratio of (emulsified) oil to water of from about 1:99 to about 70:30.

It also is possible to include a minor amount of a waxy constituent dissolved into the oil phase of the composition of the present invention, such as a vegetable wax, a microcrystalline wax, a canuba wax or a paraffin wax.

Powdery materials for which use of the dust control agent of the present invention is particularly applicable include dry soil, fertilizers, grains, used for example as animal feed, coal, glass dust, vermiculite, construction materials such as lime and cement, and flour.

As noted previously, the dust control agent of the present invention has particular advantage when used to reduce dust formation encountered during the preparation and use of glass fiber products, especially during the preparation, handling and use of glass fiber insulation products, both acoustical and thermal insulation products. Fugitive dust often is encountered during the handling of such glass fiber products as the glass fiber product cracks and disintegrates under applied stresses.

In applications where glass fiber products are manufactured, it is preferred to apply the dust control composition as part of the resin adhesive binder used to make the glass fiber product. Generally, such glass fiber products are manufactured by applying an adhesive resin binder, typically containing a thermosetting resin (e.g., a phenol-formaldehyde resin) and a catalyst, to a mat of hot glass fibers. Other resins that may be used in such applications include urea-formaldehyde resins and acrylic resins. The present invention is not limited to any particular class of glass binder resin. As understood by those skilled in the art, suitable thermosetting resins can be manufactured under alkaline conditions using a phenol to aldehyde (formaldehyde) molar ratio of about 1:1.1 to 1:5, more often in the range of 1:2 to 1:4. The present invention is not limited to any particular thermosetting resin.

The glass fibers, sprayed with a coating of the adhesive binder, are collected in the form of a non-woven fiberglass mat. Thereafter, the glass fiber mat or blanket is compressed and heated to cure the adhesive binder. Heating is often done either in an oven, or in a mold to form compressed mats or other shaped glass fiber articles. The applied heat causes the thermosetting (e.g., phenolic) resin dispersed on the glass fibers to polymerize binding the glass fibers together at sites where they overlap. The binder imparts strength and resiliency to the glass fiber product allowing them to retain their shape.

In accordance with the present invention, therefore, an adhesive binder is prepared containing not only a thermosetting (e.g., phenolic) resin and catalyst but also a dust inhibiting amount of the dust control agent of the present invention. The adhesive resin binder thus comprises an aqueous mixture of a thermosetting (e.g., phenolic) resin, urea, ammonia, a catalyst, and the dust control agent of the present invention. Suitable binders typically include about 60% to about 95% by weight water and conversely about 5% to about 40% by weight binder solids. The self-emulsifiable oil-based constituents of the dust control agent typically constitute about 0.5 to about 10 percent per weight of the solids, with the balance of the solids being the thermosetting resin (and any resin extender or other resin modifier such as urea) and catalyst.

Other conventional binder additives used when making fiberglass products also may be added to the binder destined for application to the glass fibers. Such additives include such conventional treatment components as, for example, silane coupling agents, emulsifiers, pigments, fillers, anti-migration aids, curing agents, coalescents, wetting agents, biocides, plasticizers, anti-foaming agents, colorants, waxes, and anti-oxidants.

The adhesive binder of the present invention can be conveniently prepared simply by mixing the self-emulsifiable concentrate of the polymerized (e.g., oxidized) oil and the sulfated or sulfonated oil dispersing agent with a conventional themosetting resin adhesive binder prepared for making a glass fiber product. The adhesive binder, containing the mixture of polymerized (e.g., oxidized) oil and sulfated or sulfonated oil, is then applied to the glass fibers, such as by spraying, in an amount of about 2 to 30% by weight of the glass fibers and more usually between about 4 and 20% by weight depending on the specific product involved as understood by those skilled in the art. Optimally, the amount of binder for most insulation products will be the amount necessary to lock each fiber into the mass by bonding the fibers where they cross or overlap. For this reason, it is desired to have binder compositions with good flow characteristics, so that the binder solution can be applied to the fiber at a low volume that will flow to the fiber intersections.

The polar nature of the polymerized (crosslinked for example by oxidation), unsaturated oil, and particularly an oxidized vegetable oil makes it more compatible with glass fibers and with thermosetting adhesive binder resins than the petroleum oils which have previously been used as de-dusting agents in this application. The improved compatibility translates to a longer lasting adhesion to the glass fibers and thus a longer lasting dust suppression.

The ultimate binder composition for application to the glass fibers may comprise a variety of liquid forms, including solutions, miscible liquids, or dispersions and the like and combinations of such liquid forms depending upon the optional ingredients blended into the binder composition. Where the term solution or any of the variations thereof is used herein it is intended to include any relatively stable liquid phase.

The amount of aqueous dust control agent of the present invention used in any particular application depends upon a number of factors and the specific nature of the industrial process in which it is to be applied. For example, if the aqueous dust control agent is to be used for controlling fugitive dust during the handling of a material such as coal, grain or flour, the aqueous dispersion or emulsion will typically be applied (e.g., by spraying) in an amount between about 1% and 50% by weight of the solids. Usually, the aqueous dispersion or emulsion will typically be applied in an amount between about 1% and 50% by weight of the solids. Any convenient way for applying the dust control agent to the particulate material can be used, particularly spraying.

Alternatively, the aqueous dust control agent of the present invention could simply be applied onto the surface of a pile of particulate material, such as a coal pile or gravel pile, or onto a dusty road surface, in which case it generally will be applied in an amount of about 0.05 to 5 pounds per 100 square feet, more usually 0.1 to 0.5 pounds per 100 square feet. The dust control agent of the present invention thus can be applied, such as by spraying, onto gravel construction roads, gravel pits, service roads, rural roads, gravel parking lots, mine sites, drill sites and other surfaces where fugitive dust is encountered.

The dust control agent of the present invention is environmentally compatible. The composition is biodegradable and does not cause toxic leaching or does not adversely affect vegetation or aquatic life. The composition also does not leave toxic residues in soils which distinguishes it from waste petroleum oil based compositions or latex products previously used in dust control.

The self-emulsifiable blend of the polymerized (e.g., oxidized) oil and the sulfated or sulfonated oil emulsifier exhibits a high flash point. The flash point is the temperature when a flash of flame can be detected but the flame is not sustained over the body of fluid when a flame is passed over the fluid in a cup. The test is used to determine whether a material will catch on fire at a certain temperature, such as when introduced into a hot oven. Other advantages of the dust control agent are lower VOCs, better adhesion to the dust-forming particulates and reduced misting.

It will be understood that while the invention has been described in conjunction with specific embodiments thereof, the foregoing description and examples are intended to illustrate, but not limit the scope of the invention. Other aspects, advantages and modifications will be apparent to those skilled in the art to which the invention pertains, and these aspects and modifications are within the scope of the invention, which is limited only by the appended claims.

### EXAMPLE

Dust Suppression Concentrate

A concentrate suitable for controlling dust in a glass fiber product can be prepared by mixing 80 parts by weight of an oxidized castor oil and 15 parts by weight of a sulfated castor oil containing 25 parts water. The oxidized castor oil should have been oxidized to a Gardner-Holdt viscosity of Z-6. Four parts by weight of triethanolamine and one part by weight of a 45% by weight potassium hydroxide solution in water also are added. A homogeneous blend forms upon mild agitation (mild mechanical stirring at 300-700 rpms) at ambient temperature. Before use, the concentrate so-prepared will generally be dispersed (emulsified) in water to obtain a concentration of about 50% by weight solids. Then, the dispersion (emulsion) is blended with the phenolic resin binder in an amount so that the dispersion (emulsion) constitutes about 2% by weight of the total aqueous adhesive binder weight. The binder so-prepared is then suitable for spraying onto glass fibers.

The present invention has been described with reference to specific embodiments. However, this application is intended to cover those changes and substitutions that may be made by those skilled in the art without departing from the spirit and the scope of the invention. Unless otherwise specifically indicated, all percentages are by weight. Throughout the specification and in the claims the term “about” is intended to encompass +or −5% and preferably is only about +or −2%.

We claim:

1. A dust control agent comprising an aqueous dispersion of a polymerized oil wherein said polymerized oil is dispersed in water with a sulfated or sulfonated oil.

2. The dust control agent of claim 1 wherein the sulfated or sulfonated oil is present in an amount to provide a weight ratio of the polymerized oil to the sulfated or sulfonated oil in the range of 1:99 to 99:1.

3. The dust control agent of claim 2 wherein the polymerized oil is obtained by polymerizing unsaturated oil selected from the group consisting of linseed oil, castor oil, tung oil, soybean oil, cottonseed oil, olive oil, canola oil, corn oil, sunflower seed oil, coconut oil, safflower oil, tall oil, palm oil and mixtures thereof.

4. The dust control agent of claim 3 wherein the polymerized oil is obtained by oxidizing said unsaturated oil or mixture of oils.

5. The dust control agent of claim 4 wherein the sulfated or sulfonated oil is a sulfated or sulfonated vegetable oil and the sulfated or sulfonated vegetable oil is present in an amount to provide a weight ratio of the polymerized oil to the sulfated or sulfonated vegetable oil in the range of 10:90 to 95:5.

6. A method of controlling fugitive dust which comprises treating a particulate material susceptible to developing fugitive dust with a dust inhibiting amount of the dust control agent of claim 1.

7. The method of claim 6 wherein the polymerized oil is obtained by polymerzing an unsaturated oil selected from the group consisting of linseed oil, castor oil, tung oil, soybean oil, cottonseed oil, olive oil, canola oil, corn oil, sunflower seed oil, coconut oil, safflower oil, tall oil, palm oil and mixtures thereof.

8. The method of claim 7 wherein the polymerized oil is obtained by oxidizing said unsaturated oil or mixture of oils.

9. The method of claim 8 wherein the sulfated or sulfonated oil is a sulfated or sulfonated vegetable oil and the sulfated or sulfonated vegetable oil is present in an amount to provide a weight ratio of the polymerized oil to the sulfated or sulfonated vegetable oil in the range of 10:90 to 95:5.

10. A method for preparing a glass fiber product comprising the steps of:
contacting hot glass fibers with an adhesive binder comprising an aqueous dispersion of a thermosetting resin, a catalyst and the dust control agent of claim 1;
forming the glass fibers contacted with the adhesive binder into a non-woven mat, and
heating the mat to cure the adhesive binder.

11. The method of claim 10 wherein the polymerized oil is obtained by polymerizing an unsaturated oil selected from the group consisting of linseed oil, castor oil, tung oil, soybean oil, cottonseed oil, olive oil, canola oil, corn oil, sunflower seed oil, coconut oil, safflower oil, tall oil, palm oil and mixtures thereof.

12. The method of claim 11 wherein the polymerized oil is obtained by oxidizing said unsaturated oil or mixture of oils.

13. The method of claim 12 wherein the sulfated or sulfonated oil is a sulfated or sulfonated vegetable oil and the sulfated or sulfonated vegetable oil is present in an amount to provide a weight ratio of the polymerized oil to the sulfated or sulfonated vegetable oil in the range of 10:90 to 95:5.

14. A composition suitable for preparing a dust control agent comprising a blend of a polymerized oil and a sulfated or sulfonated oil dispersing agent in an amount to provide a weight ratio of the polymerized oil to the sulfated or sulfonated vegetable oil in the range of 1:99 to 99:1.

15. The composition of claim 14 wherein the polymerized oil is obtained by polymerizing an unsaturated oil selected from the group consisting of linseed oil, castor oil, tung oil, soybean oil, cottonseed oil, olive oil, canola oil, corn oil, sunflower seed oil, coconut oil, safflower oil, tall oil, palm oil and mixtures thereof.

16. The composition of claim 15 wherein the polymerized oil is obtained by oxidizing said unsaturated oil or mixture of oils.

17. The composition of claim 16 wherein the sulfated or sulfonated oil is a sulfated or sulfonated vegetable oil and the sulfated or sulfonated vegetable oil is present in an amount to provide a weight ratio of the polymerized oil to the sulfated or sulfonated vegetable oil in the range of 10:90 to 95:5.

18. An adhesive binder composition for glass fiber products comprising an aqueous dispersion of a thermosetting resin, a catalyst and the dust control agent of claim 1.

19. The adhesive binder of claim 18 wherein the polymerized oil is obtained by polymerizing an unsaturated oil selected from the group consisting of linseed oil, castor oil, tung oil, soybean oil, cottonseed oil, olive oil, canola oil, corn oil, sunflower seed oil, coconut oil, safflower oil, tall oil, palm oil and mixtures thereof.

20. The adhesive binder of claim 19 wherein the polymerized oil is obtained by oxidizing said unsaturated oil or mixture of oils.
